(19) United States
(12) Patent Application Publication
(10) Pub. No.: US 2009/0002414 A1
(43) Pub. Date: Jan. 1, 2009

(54) INKJET PRINTING APPARATUS AND PRINTING METHOD

(75) Inventors: Tsuyoshi Shibata, Yokohama-shi (JP); Hiromitsu Yamaguchi, Yokohama-shi (JP); Satoshi Wada, Machida-shi (JP); Ryoki Jahana, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/145,011

(22) Filed: Jun. 24, 2008

(30) Foreign Application Priority Data
Jun. 28, 2007 (JP) 2007-171224

(51) Int. Cl. B41J 29/38

(52) U.S. Cl. 347/9

(57) ABSTRACT

There is provided an inkjet printing apparatus which prints using a printhead for discharging ink by a plurality of scanning operations of the printhead including forward scanning and reverse scanning in a single area of a print medium. In the inkjet printing apparatus, the ink discharge amount is acquired for each unit area obtained by dividing the end area of the single area in the scanning direction. The acquired ink discharge amount of each unit area is compared with a predetermined threshold. The printing ratios of the plurality of scanning operations are controlled to set the printing ratio of the final scanning operation lower than the average one of the remaining scanning operations in a unit area where the ink discharge amount is larger than the predetermined threshold.

### BACKGROUND OF THE INVENTION

1. Field of the Invention

The present invention relates to an inkjet printing apparatus which prints an image with ink containing a color material and a printing method therefor. More particularly, the present invention relates to an inkjet printing apparatus which forms an image by multipass printing by reciprocally scanning a multi-nozzle inkjet printhead (to be also simply referred to as a printhead hereinafter) having an array of nozzles for discharging ink with respect to a print medium, and a printing method therefor.

2. Description of the Related Art

As information processing devices such as a computer have become popular and communication devices have spread upon improvement of the communication environment, an inkjet printing apparatus which prints a digital image using an inkjet printhead is rapidly becoming pervasive as one of printing apparatuses used together with these devices.

A kind of inkjet printing apparatus uses a printhead having an array of nozzles to increase the printing speed. To print a color image, a general inkjet printing apparatus uses a printhead having arrays of nozzles each made up of an ink orifice, liquid channel, and the like.

Users have requested higher image qualities. When printing a color image, it is important to print an image excellent in color development, tonality, evenness, and the like. However, slight structural variations during the manufacturing process of a multi-nozzle printhead influence the ink discharge amount and discharge direction of each nozzle in printing. This generates a stripe and density unevenness in a printed image, degrading the image quality.

To reduce such a stripe and density unevenness in a printed image, a multipass printing mode (divisional printing) has been proposed (see U.S. Pat. No. 4,748,453 and Japanese Patent Laid-Open Nos. 58-194541 and 55-113573). These references disclose a method (multipass printing) of dividing the nozzle array into a plurality of blocks by a predetermined paper feed width, repeating scanning of the printhead and feeding of paper a plurality of number of times, and divisionally printing a printing area corresponding to the paper feed width using nozzles of different blocks in respective scanning operations.

Multipass printing is effective for reducing density unevenness caused by the nozzle discharge amount distribution or landing error, reducing color unevenness in reciprocal printing, preventing ink bleeding, and the like.

However, unlike 1-pass printing, multipass printing increases the number of print scanning operations till the completion of an image, decreasing the throughput. As the number of passes increases, a stripe and density unevenness in a printed image is reduced, but the throughput decreases.

To increase the throughput, there is proposed a bidirectional printing method of printing even when the printhead reverses its scanning direction to scan in the reverse after performing scan printing in the forward (see Japanese Patent Laid-Open No. 2001-80093 and U.S. Pat. No. 6,086,181).

However, it is known that “application order color unevenness” and “time difference unevenness” occur if bidirectional printing is done by a relatively small number of passes (two to six passes). A variety of measures against these problems have been examined. “Application order color unevenness” and “time difference unevenness” will be explained in detail below.

“Application Order Color Unevenness”

For example, printing is done using a printhead J0010 having head chips 2802 for respective colors that discharge four, black (K), yellow (Y), magenta (M), and cyan (C) color inks from orifices 2803 via ink channels 2805 and 2804, as shown in FIG. 15. The printhead J0010 reciprocates in a direction (right-and-left direction in FIG. 15) perpendicular to the array direction of the orifices 2803, thereby printing the same printing area by three scanning operations (three passes).

“Application order color unevenness” will be explained with reference to FIG. 6.

In forward scanning as the first scanning, printing is done while the printhead moves to the right in FIG. 6. In printing pass 6-001, ⅓ nozzles on the upstream side (to be referred to as a leading end hereinafter) of the nozzle array in the print medium conveyance direction discharge the respective inks. The ink dots land in the order of C, M, Y, and K in a printing area 6-A.

After paper is fed by a ⅓ width of the nozzle array, printing is done by reverse scanning as the second scanning while the printhead moves to the left in FIG. 6. In printing pass 6-002, ⅔ nozzles at the leading end of the nozzle array discharge the respective inks, and the ink dots land in the order of K, Y, M, and C in printing areas 6-A and 6-B. At this time, ⅓ nozzles at the leading end of the nozzle array discharge ink while moving in the reverse direction. Thus, ink dots land in the order of K, Y, M, and C by the first pass in the printing area 6-B, and ink dots land in the order of K, Y, M, and C by the second pass in the printing area 6-A.

In forward scanning as the third scanning, printing is done while the printhead moves to the right in FIG. 6. In printing pass 6-003, all the nozzles of the nozzle array discharge the respective inks, and the ink dots land in the order of C, M, Y, and K in each printing area.

More specifically, the ink dot landing order in the printing area 6-A is C, M, Y, and K by the first pass→K, Y, M, and C by the second pass→C, M, Y, and K by the third pass. The ink dot landing order in the printing area 6-B is K, Y, M, and C by the first pass→C, M, Y, and K by the second pass→K, Y, M, and C by the third pass. In subsequent printing, this relationship between the printing areas 6-A and 6-B is repeated to print.

After printing in this manner, the color formed on the print medium sometimes becomes different between a portion corresponding to the printing area 6-A and a portion corresponding to the printing area 6-B. For example, when a predetermined area is printed in green using cyan and yellow inks, ink dots land at the portion corresponding to the printing area 6-A in the order of cyan ink→yellow ink by the first pass. At the portion printed by the first pass, cyan ink landed first is dominant, and ink dots of cyan-rich green may be formed. To the contrary, the application order in the second pass is opposite to that in the first pass because printing is done while the printhead moves in the opposite direction. As a result, ink dots of yellow-rich green are formed. The third pass forms dots of cyan-rich green, similar to the first pass.

When an image is complete by repeating three print scanning operations in the same area, cyan stands out in the printing area 6-A because ink dots of cyan-rich green are dominant. In contrast, yellow stands out in the printing area 6-B because dots of yellow-rich green are dominant.

Printing areas (bands) in different color tints alternately appear on the basis of the application order of different color inks, and degradation of the image quality occurs as band unevenness. FIG. 7 is an explanatory view when printing is performed on a print medium in the above-described way. In FIG. 7, areas in different color tints appear every paper feed width.

The application order color unevenness can be reduced by increasing the number of passes (scanning operations) to perform multipass printing such as 8- or 16-pass printing, but the multipass printing decreases the throughput. Even if multipass printing is executed by increasing the number of passes, application order color unevenness may still occur depending on the ink type and print medium type. Multipass printing is not the best solution.

It is known that “time difference unevenness” occurs when trying to achieve both a decrease in the number of passes in multipass bidirectional printing and a short reverse time of a carriage for moving the printhead in order to implement high-speed printing.

“Time Difference Unevenness”

FIG. 8 shows time difference unevenness when performing 2-pass bidirectional printing.

In 2-pass bidirectional printing, the printhead moves from the printing start position at the left end in FIG. 8 in the first scanning, and half nozzles at the leading end of the nozzle array discharge ink of almost half of ink dots necessary to form a desired image, thereby printing. Then, the carriage reverses quickly at the right end in FIG. 8, and paper is fed by a predetermined paper feed amount (amount corresponding to a half length of the nozzle array).

In an area printed by the remaining half nozzles on the downstream side (to be referred to as a trailing end hereinafter) of the nozzle array in the print medium conveyance direction, printing is done by landing ink dots at positions where the ink dots complement those printed by the first scanning. At the same time, in an area printed by the half nozzles at the leading end of the nozzle array, printing is done by discharging ink of almost half of ink dots necessary to form a desired image, similar to printing by the first scanning.

Subsequently, the carriage reverses quickly at the printing start position, paper is fed by a predetermined paper feed amount, and printing is done by the third scanning. At this time, the half nozzles at the leading end of the nozzle array print similarly to printing by the first scanning. The half nozzles at the trailing end of the nozzle array print by landing ink dots at positions where the ink dots complement those printed by the second scanning.

In this printing, attention is paid to printing area A where printing of an image starts. The time interval until printing by the second pass starts after printing by the first pass is the sum of the time taken to print by the image width and the time taken to reverse the carriage. If the time taken to feed paper at the same time as reverse of the carriage is longer than the time taken to reverse the carriage, the difference between these times is also added.

In printing area B adjacent to printing area A, printing by the second pass starts after printing by the first pass at a very short time interval mainly determined by the time taken to reverse the carriage and the time taken to feed paper.

From this, as the width of an image to be printed is larger, the time difference (inter-pass time difference) until printing by the second pass starts after printing by the first pass in printing area A more greatly differs from the inter-pass time difference in printing area B. This difference becomes very large when, for example, printing on a print medium of a large format such as A4 size or more. The image density and color tone become different between adjacent bands at the two ends of a printed image, and density unevenness may occur at the paper feed pitch.

This phenomenon is considered to occur because the color material in ink penetrates deeply into the print medium when, for example, cyan and magenta inks land in order and the landing time difference ΔT between these inks is small, but shallowly when the landing time difference is large, as shown in FIG. 14.

For descriptive convenience, 2-pass bidirectional printing has been described. Also, in bidirectional printing by multiple passes larger than two passes, density unevenness may occur because the image density and color tone change owing to the ink landing time difference. A case where time difference unevenness occurs in 4-pass printing will be exemplified with reference to FIGS. 9 and 10 as a case where time difference unevenness occurs even in printing by multiple passes larger than two passes.

A printing area 9-A in FIG. 9 is printed by first print scanning 9-001 by discharging ink of almost ¼ of ink dots necessary to form a desired image. Then, the printing area 9-A is printed by second print scanning 9-002 by discharging ink of almost ¼ of ink dots necessary to form a desired image. In printing area A of FIG. 10 corresponding to part of the printing area 9-A, the sum of the time taken to print by an image width and the time taken to reverse the carriage is required until printing by the second pass starts after printing by the first pass. In third print scanning 9-003, printing is performed at a time difference corresponding to only the time taken to reverse the carriage after printing by the second pass. In fourth print scanning 9-004, printing is performed at a time difference corresponding to the sum of the time taken to print by an image width and the time taken to reverse the carriage is taken after printing by the third pass.

In printing area B of FIG. 10 corresponding to part of the printing area 9-B, printing by the second pass is performed at a time difference corresponding to almost only the time taken to reverse the carriage after printing by the first pass. Printing by the third pass is performed at a time difference corresponding to the sum of the time taken to print by an image width and the time taken to reverse the carriage after printing by the second pass. Then, printing by the fourth pass is performed at a time difference corresponding to only the time taken to reverse the carriage after printing by the third pass.

As shown in FIG. 9, in the printing area 9-A, printing proceeds in the ink discharge order of CMYK, KYMC, CMYK, and KYMC at time difference intervals of large time difference, small time difference, and large time difference. In the printing area 9-B, printing proceeds in the ink discharge order of KYMC, CMYK, KYMC, and CMYK at time difference intervals of small time difference, large time difference, and small time difference.

Since the ink discharge order and time difference interval change, this also causes density (color tone) unevenness between bands at the end of an image, as shown in FIG. 9. Further, the density differs between the right and left ends on the same band, as shown in FIG. 10, and the density difference alternately appears, generating comb-tooth band unevenness.

As described above, to obtain high image quality by a small number of passes when performing bidirectional printing in an inkjet printing apparatus which forms an image by a plurality of print scanning operations of the printhead, “application order color unevenness” and “time difference unevenness” must be canceled.

Known techniques have improved “application order color unevenness” to a certain extent in accordance with recent demand for higher image qualities. However, “time difference unevenness” has not been satisfactorily improved yet.

“Time difference unevenness” is particularly conspicuous when the printhead reverses (kicks back) quickly and when an image of a large size (A4 or more: large format) is printed. To increase the throughput in printing a large-format image, it is important to cancel time difference unevenness.

As a technique associated with time difference unevenness, when completing an image by two reciprocal (2-pass bidirectional) print scanning operations, the allocation of printing in the scanning direction in print scanning by the first pass is gradually increased to print at positions where ink dots are complemented by the second pass (see Japanese Patent Laid-Open No. 2004-82624). In 2-pass printing, this technique decreases the printing allocation to the first pass at a printing position where the time difference between print scanning by the first pass and that by the second pass becomes large, and increases the printing allocation to the first pass at a printing position where the time difference becomes small.

Another associated technique decreases the printing ratio by a preceding pass in a high-density image area (see Japanese Patent Laid-Open No. 2004-209943).

There is also disclosed a technique of changing the allocation of printing ratios to passes in multipass printing. For example, a technique of printing by increasing the printing ratio of a preceding pass in the multipass printing mode is disclosed (see Japanese Patent Laid-Open No. 6-286161). For example, when printing a pixel by seven ink dots by four passes, two ink dots are discharged by each of the first to third passes, and one ink dot is discharged by the fourth pass. A technique of gradually decreasing the printing ratios of succeeding ones of all passes in multipass printing is also disclosed (see Japanese Patent Laid-Open No. 2003-182051). Further, a technique of gradually decreasing the printing ratios of preceding passes in the multipass printing mode is disclosed (see Japanese Patent Laid-Open No. 2001-063015).

The technique in Japanese Patent Laid-Open No. 2004-82624 can reduce time difference unevenness in 2-pass printing. However, this reference does not disclose any measure for multiple passes larger in number than two passes. Thus, in multiple passes larger in number than two passes, another measure is needed to change the printing allocation in the print scanning direction.

The technique in Japanese Patent Laid-Open No. 2004-209943 can reduce bleeding at the boundary that occurs every paper feed width. However, this technique is one for reducing bleeding at the boundary that occurs every paper feed width, and this reference does not describe the allocation of the printing ratio necessary to reduce time difference unevenness.

The present inventors have extensively studied to find out that “application order color unevenness” and “time difference unevenness” described above can be reduced by optimizing the allocation of printing ratios to passes in performing multipass printing. For example, when printing by four passes with dye ink on inkjet paper whose ink receiving layer is coated, the printing ratios of the first and final passes are set low, reducing the unevenness. However, the techniques in Japanese Patent Laid-Open Nos. 6-286161 and 2003-182051 for changing the allocation of printing ratios to passes increase the printing ratio of a preceding pass in order to make the “overflow” state of a print medium uniform on the print medium, and do not aim to reduce the unevenness. Note that “overflow” of a print medium is a phenomenon that ink applied to a print medium overflows from an area for absorbing ink, such as the ink receiving layer of a print medium. “Overflow” degrades the image quality owing to poor ink fixing characteristic. This means that the fixing state of the color material changes depending on the wet state of the ink receiving layer during the ink penetration/fixing process. It is effective for reducing “application order unevenness” and “time difference unevenness” to control the “overflow” state until an image is formed. For this purpose, it is considered to be effective to set the printing ratio of the final pass low, and also set that of the first pass low.

According to the technique of setting different printing ratios for respective passes in performing multipass printing, the nozzle use frequency is localized, as described in even Japanese Patent Laid-Open No. 2003-182051. Owing to this localization, a frequently used nozzle greatly deteriorates over time, shortening the service life of the printhead. Further, under the influence of an air flow generated upon discharging ink, a boundary stripe readily appears at the boundary between a portion printed by a nozzle which prints at low printing ratio and that printed by a nozzle which prints at high printing ratio.

### SUMMARY OF THE INVENTION

It is an object of the present invention to provide an inkjet printing apparatus capable of leveling the nozzle use frequency, and canceling application order color unevenness and time difference unevenness without generating any boundary stripe when performing multipass printing, and a printing method therefor.

According to the first aspect of the present invention, an inkjet printing apparatus which prints using a printhead for discharging ink by a plurality of scanning operations of the printhead including forward scanning and reverse scanning in a single area of a print medium, the apparatus comprising:

acquisition means for acquiring an ink discharge amount for each unit area obtained by dividing an end area of the single area in a scanning direction;

comparison means for comparing the ink discharge amount of each unit area acquired by the acquisition means with a predetermined threshold; and

control means for controlling printing ratios of the plurality of scanning operations to set a printing ratio of a final scanning operation lower than an average printing ratio of remaining scanning operations in a unit area where the ink discharge amount is larger than the predetermined threshold.

In a preferred embodiment, the control means controls to make printing ratios of the plurality of scanning operations equal to each other in a unit area where the ink discharge amount is not larger than the predetermined threshold.

In a preferred embodiment, the control means controls to set the printing ratio of the final scanning operation lower than the average printing ratio of the remaining scanning operations in a unit area where the ink discharge amount is not larger than the predetermined threshold, and

the control means controls to set a difference between the printing ratio of the final scanning operation and the average printing ratio of the remaining scanning operations in the unit area where the ink discharge amount is not larger than the threshold smaller than a difference between the printing ratio of the final scanning operation and the average printing ratio of the remaining scanning operations in the unit area where the ink discharge amount is larger than the threshold.

In a preferred embodiment, the threshold is different between the end area on one end in the scanning direction and the end area on the other end.

In a preferred embodiment, when printing stops,

the acquisition means acquires an ink discharge amount till the stop for each unit area,

the comparison means compares the ink discharge amount till the stop acquired by the acquisition means for each unit area with a second threshold smaller than the threshold, and

the control means controls the printing ratios of the plurality of scanning operations to set the printing ratio of the final scanning operation lower than the average printing ratio of the remaining scanning operations after the stop in a unit area where the ink discharge amount till the stop is larger than the second threshold.

According to the second of the present invention, an inkjet printing method of printing using a printhead for discharging ink by a plurality of scanning operations of the printhead including forward scanning and reverse scanning in a single area of a print medium, the method comprising:

an acquisition step of acquiring an ink discharge amount for each unit area obtained by dividing an end area of the single area in a scanning direction; and

a comparison step of comparing the ink discharge amount of each unit area acquired in the acquisition step with a predetermined threshold,

wherein printing ratios of the plurality of scanning operations are controlled to set a printing ratio of a final scanning operation lower than an average printing ratio of remaining scanning operations in a unit area where the ink discharge amount is larger than the predetermined threshold.

Further features of the present invention will be apparent from the following description of exemplary embodiments with reference to the attached drawings.

### BRIEF DESCRIPTION OF THE DRAWINGS

FIG. 1 is a block diagram mainly showing the hardware and software configurations of a PC functioning as a host apparatus according to an embodiment of the present invention;

FIG. 2 is a block diagram for explaining main data processes in the PC and a printer when the printer prints;

FIG. 3 is a perspective view of an inkjet printing apparatus according to the embodiment of the present invention;

FIG. 4 is a view schematically showing a printhead, mask pattern, and print medium in order to explain 2-pass printing;

FIG. 5 is a view schematically showing a printhead and printing pattern in order to explain 2-pass printing;

FIG. 6 is a view for explaining application order color unevenness;

FIG. 7 is a view showing an example in which application order color unevenness occurs;

FIG. 8 is a view showing an example in which time difference unevenness occurs;

FIG. 9 is a view for explaining time difference unevenness;

FIG. 10 is a view showing an example in which time difference unevenness occurs;

FIG. 11 is a view for explaining a printing method according to the embodiment of the present invention;

FIG. 12 is a view for explaining the printing method according to the embodiment of the present invention;

FIG. 13 is a view for explaining the printing method according to the embodiment of the present invention;

FIG. 14 is a view for explaining depths to which the color material penetrates into a print medium when the ink landing time difference is small and large;

FIG. 15 is a plan view for explaining a printhead used in the present invention;

FIG. 16 is a plan view for explaining the printhead used in the present invention;

FIG. 17 is a block diagram showing main data processes till printing in the embodiment of the present invention;

FIG. 18 is a view for explaining the allocation of the printing ratio in an image area where the ink application amount exceeds a threshold and an image area where the ink application amount is equal to or smaller than the threshold in the embodiment of the present invention;

FIG. 19 is a view for explaining the allocation of the printing ratio in an image area where the ink application amount exceeds the threshold and an image area where the ink application amount is equal to or smaller than the threshold in the embodiment of the present invention; and

FIG. 20 is a flowchart showing the printing method according to the embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

In this specification, the term “print” (to be also referred to as “printing” hereinafter) not only includes the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium” not only includes paper used in general printing apparatuses, but also broadly includes materials capable of accepting ink, such as cloth, a plastic film, a metal plate, glass, ceramics, wood, and leather.

Further, the term “ink” should be extensively interpreted similar to the definition of “print” described above. That is, “ink” includes a liquid which, when applied onto a print medium, can form images, figures, patterns, and the like, can process the print medium, and can process ink. Ink processing includes solidification or insolubilization of a color material contained in ink applied to the print medium.

Unless otherwise specified, the term “nozzle” generally means a set of an orifice, a liquid channel connected to the orifice, and an element to generate energy utilized for ink discharge.

In the embodiments of the present invention, print data is generated for use in each scanning of multipass printing of printing while scanning the same area of a print medium a plurality of number of times in the forward and reverse directions. When generating print, input multilevel image data is converted into binary print data used for printing an image. Then, the print data is divided in accordance with the division mask, and each divided print data is printed by each print scanning.

The present invention is also applicable to a case where input multilevel data is directly divided based on allocation ratio information, and the divided multilevel data is binarized into divided print data.

In the present invention, when the printing operation suspends during printing, an image to be printed is reallocated and printed.

An inkjet printing apparatus and a printing method therefor according to the present invention will be described.

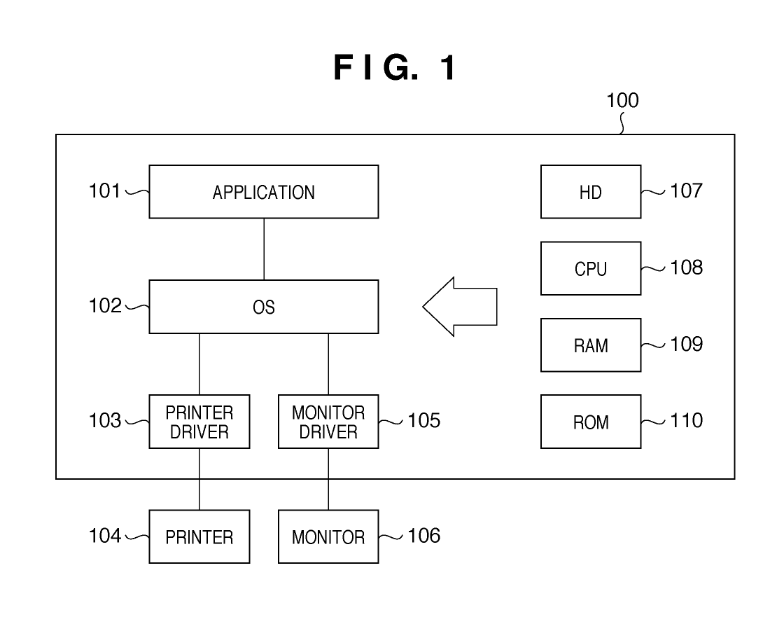

FIG. 1 is a block diagram mainly showing the hardware and software configurations of a personal computer (to be simply referred to as a PC hereinafter) functioning as a host apparatus according to an embodiment of the present invention.

The host apparatus generates image data to be printed by a printer 104.

In FIG. 1, a PC 100 serving as a host apparatus operates software including an application 101, printer driver 103, and monitor driver 105 under the control of an operating system (OS) 102.

The application 101 executes processes associated with word processing, spreadsheet, Internet browser, and the like. The monitor driver 105 creates image data to be displayed on a monitor 106.

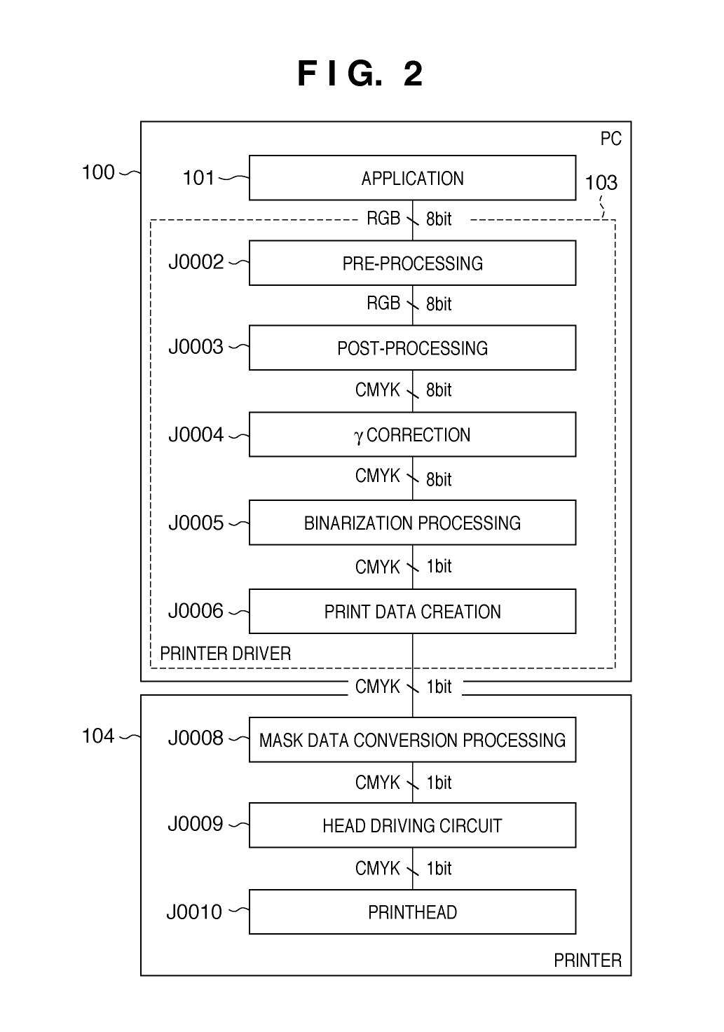

The printer driver 103 performs rendering processing in accordance with various rendering instructions (image rendering instruction, text rendering instruction, graphics rendering instruction, and the like) issued from the application 101 to the OS 102. The printer driver 103 generates multilevel or binary image data to be finally used in the printer 104. More specifically, the printer driver 103 executes image processing (to be described later with reference to FIG. 2) to generate multilevel or binary image data corresponding to inks of a plurality of colors used in the printer 104.

The PC 100 comprises a CPU 108, hard disk (HD) 107, RAM 109, and ROM 110 as various hardware units for operating these software programs. The CPU 108 executes the processes of the software programs stored in the hard disk 107 and ROM 110. The RAM 109 is used as a work area when executing the processes.

The printer 104 in the embodiment is a so-called serial printer which prints by discharging ink while scanning a printhead for discharging ink with respect to a print medium. Printheads are prepared in correspondence with respective inks such as cyan (C), magenta (M), yellow (Y), and black (K) inks. These printheads are mounted in the carriage to scan a print medium. Each printhead has an orifice array density of 1,200 dpi, and discharges ink droplets of 4.5 pl or the like from each orifice. Each printhead has, e.g., 1,280 orifices.

The printer 104 is a printing apparatus capable of executing multipass printing. To execute multipass printing, a mask to be described in each embodiment is stored in a predetermined memory. In printing, the printer 104 generates binary divided print data by referring to a memory for a mask determined by the scanning direction, scanning count, and ink color. When image data input to the printer 104 is multilevel image data, the printer 104 divides the multilevel image data in accordance with allocation ratio information (to be described later), and converts the divided multilevel image data into divided print data.

FIG. 2 is a block diagram for explaining main data processes in the PC 100 and printer 104 when the printer 104 in FIG. 1 prints.

The inkjet printer 104 in the embodiment prints with four, cyan, magenta, yellow, and black color inks, as described above. For this purpose, the printer 104 comprises the printhead J0010 for discharging these four color inks.

The user can use the application 101 of the PC 100 to create image data to be printed by the printer 104. When printing, the image data created by the application 101 is transferred to the printer driver 103.

The printer driver 103 executes pre-processing J0002, post-processing J0003, γ correction J0004, binarization processing J0005, and print data creation J0006.

In the pre-processing J0002, the printer driver 103 performs color gamut conversion to convert the color gamut of an application window on the display into that of the printer 104. More specifically, the printer driver 103 converts image data representing each of R, G, and B by 8 bits into 8-bit data in the color gamut of the printer on the basis of a 3D LUT.

In the post-processing J0003, to reproduce the color gamut of the image data converted by the pre-processing J0002 by the ink color, the printer driver 103 decomposes the color represented by the image data into ink colors. More specifically, the printer driver 103 obtains 8-bit data of C, M, Y, and K color components corresponding to ink colors in order to reproduce the colors of R, G, and B color components represented by the 8-bit data obtained by the pre-processing J0002.

In the γ correction J0004, the printer driver 103 performs γ correction for each of the data of C, M, Y, and K color components obtained by the post-processing J0003. More specifically, the printer driver 103 converts the 8-bit C, M, Y, and K data obtained by the post-processing J0003 to linearly correspond to the tone characteristic of the printer. At this stage, the data may also be transferred as input multilevel image data to the printer 104.

In the binarization processing J0005, the printer driver 103 performs quantization processing to convert the γ-corrected 8-bit C, M, Y, and K data into 1-bit C, M, Y, and K data.

Finally in the print data creation J0006, the printer driver 103 creates print data by adding printing control data and the like to image data which are multilevel data before quantization or 1-bit binary C, M, K, and Y data. The binary image data contains dot printing data representing printing of a dot, and dot non-printing data representing printing of no dot. The printing control data contains “print medium information”, “print quality information”, and “other control information” such as the paper feed method.

The PC 100 supplies the generated print data to the printer 104.

The printer 104 executes mask data conversion processing J0008 for binary image data contained in print data input from the PC 100 serving as an external apparatus. In the mask data conversion processing J0008, the printer 104 ANDs input binary image data to obtain binary divided print data by using a mask pattern (to be described later in each embodiment) that is stored in advance in a predetermined memory of the printer 104. The printer 104 converts input multilevel image data into multilevel data divided based on allocation ratio information (to be described later), and binarizes the divided multilevel data, attaining binary divided print data. As a result, binary divided print data used for each scanning in multipass printing is generated, and the timing to actually discharge ink is determined. The binary divided print data contains dot printing data and dot non-printing data.

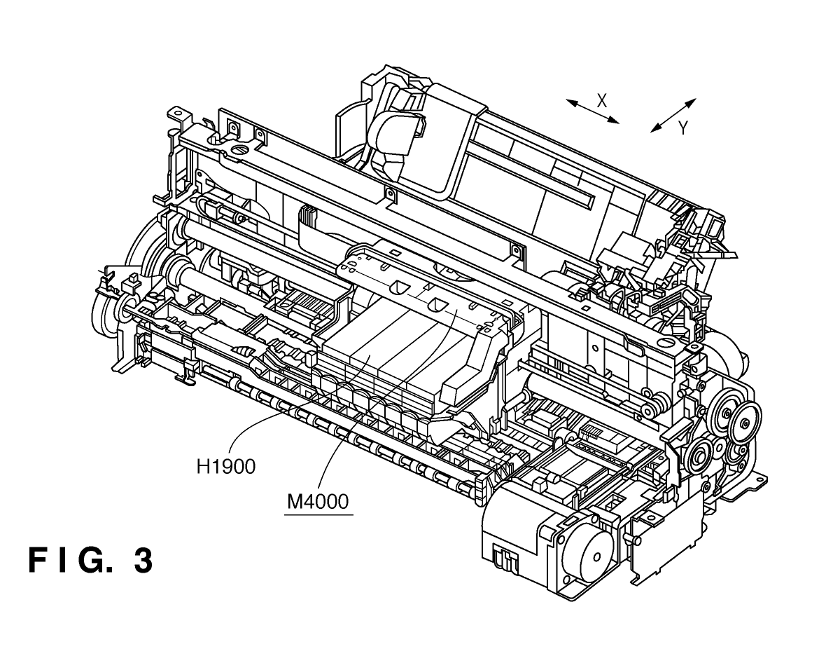

FIG. 3 is a perspective view showing the inkjet printer 104.

A carriage M4000 supports a printhead, and ink tanks H1900 for supplying cyan (C), magenta (M), yellow (Y), and black (K) inks to the printhead. In this state, the carriage M4000 moves in the X direction (main scanning direction) in FIG. 3, and each nozzle (printing element) of the printhead discharges ink at a predetermined timing on the basis of binary divided print data. After the end of one scanning of the printhead, the print medium is conveyed by a predetermined amount in the Y direction (sub-scanning direction) perpendicular to the main scanning direction. After that, bidirectional scan printing in the main scanning direction and conveyance of a print medium by a predetermined amount in the sub-scanning direction are sequentially repeated to print an image in each scanning area, outputting a printed material.

The following description is directed to processing of converting image data into binary print data, inputting the print data to the inkjet printer, dividing the input print data into binary divided print data by a division mask, and printing on the basis of the divided print data.

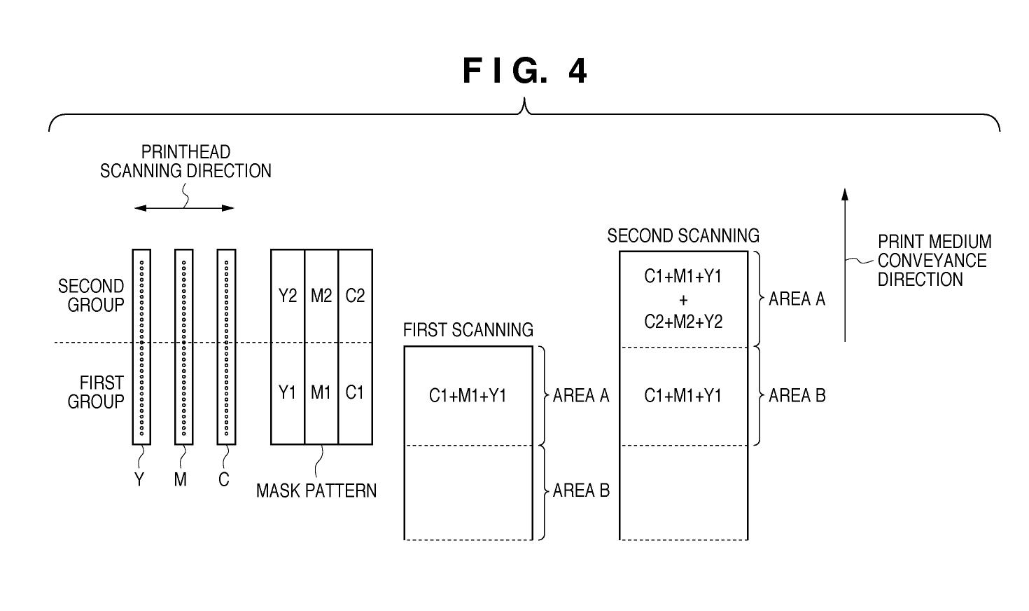

FIG. 4 is a view schematically showing the printhead, mask pattern, and print medium in order to explain 2-pass printing. A case where printing is performed with three, cyan, magenta, and yellow color inks will be exemplified.

Nozzles (nozzles of each color) for discharging each color ink are divided into two, first and second groups, and each group includes 640 nozzles. A mask pattern corresponds to each group. Although the size of each mask pattern is arbitrarily set in the embodiment (to be described later), the mask pattern has a size of 640 pixels in the main scanning direction and 640 pixels in the sub-scanning direction which are equal to the number of nozzles of each group. Two mask patterns (Y1 and Y2, M1 and M2, or C1 and C2) corresponding to nozzle groups of the same color ink are complementary to each other. By overlaying the two mask patterns, printing in an area corresponding to 640×640 pixels is complete. However, mask patterns are not limited to them.

Nozzles of each color discharge ink onto a print medium while moving in a direction (“printhead scanning direction” indicated by an arrow in FIG. 4) substantially perpendicular to the nozzle array direction. In this example, C, M, and Y inks are discharged to each area. Every time scanning of the printhead ends, the print medium is conveyed by the width (640 pixels in this case) of one group in a direction (“print medium conveyance direction” indicated by an arrow in FIG. 4) perpendicular to the scanning direction. An image is complete by two scanning operations in an area of the print medium that has a width corresponding to the group width.

More specifically, in the first scanning, area A on a print medium is printed using nozzles of the first group in the order of C, M, and Y. When printing area A by the first scanning, the mask patterns C1, M1, and Y1 are used. In the second scanning, area A where printing by the first scanning has ended is printed using nozzles of the second group in the order of Y, M, and C at positions where printing by the first scanning is complemented. At the same time, unprinted area B is printed using nozzles of the first group in the order of Y, M, and C. When printing by the second scanning, the mask patterns C2, M2, and Y2 are used for area A, and the mask patterns C1, M1, and Y1 are used for area B. This operation continues to print in the respective areas of the print medium.

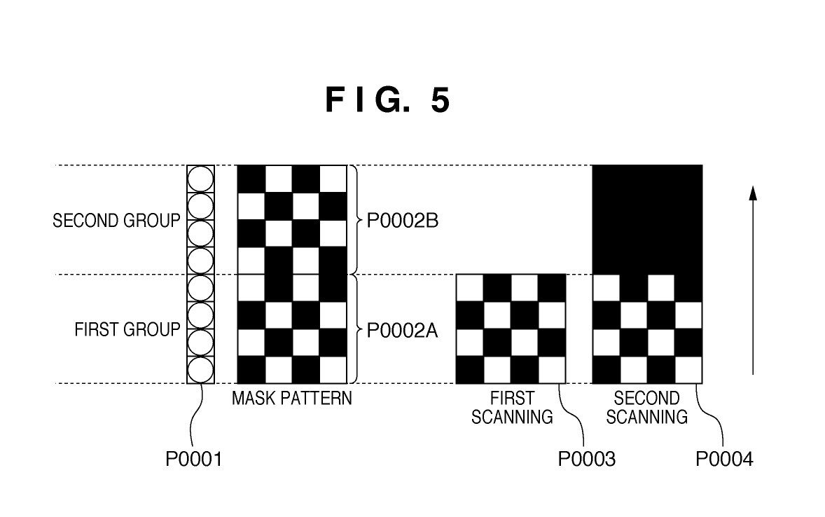

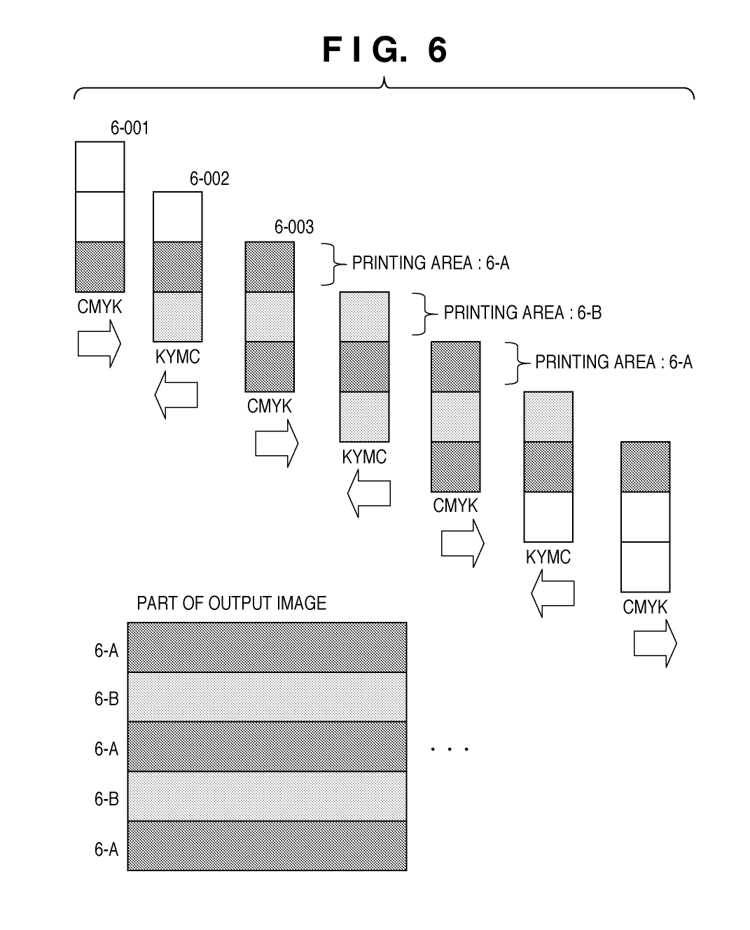

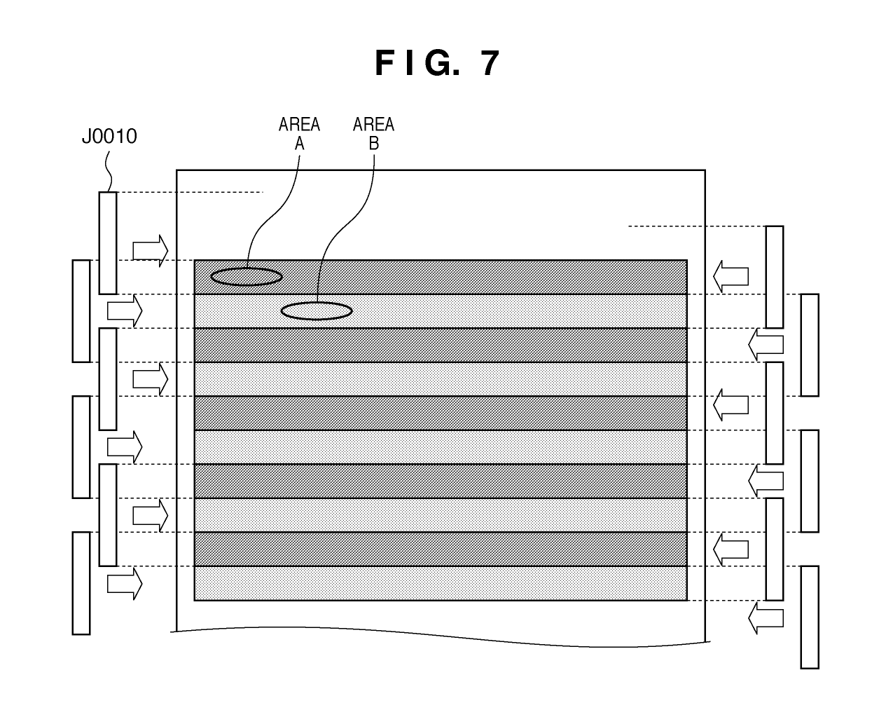

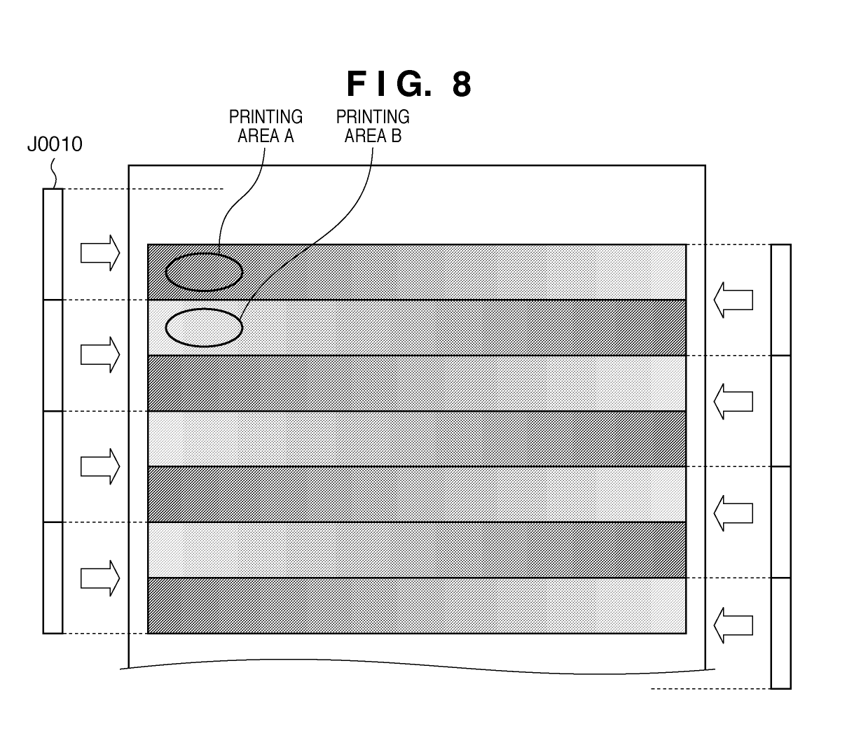

In FIG. 5, P0003 and P0004 represent dot layouts of an image completed by 2-pass printing.

For descriptive convenience, this image is a so-called solid image in which dots are formed in all pixels. Hence, an image is printed with a dot layout directly reflecting the layout of printable pixels of a mask P0002 (mask patterns P0002A and P0002B).

In the first scanning, dot print data of the first group is generated using the mask pattern P0002A. The print medium is conveyed by the width of the nozzle group in a direction indicated by an arrow in FIG. 5. In the second scanning, dot print data of the first group for an area shifted by the conveyance amount is generated similarly using the mask pattern P0002A. Dot print data of the second group for printing the area printed by the first group is generated using the mask pattern P0002B. By the two print scanning operations, printing of an image in an area corresponding to the width of the nozzle group is complete. By alternately repeating print scanning and conveyance of the print medium, an image is sequentially formed by multipass printing.

By increasing the number of passes to three or four in multipass printing, the number of print scanning operations by which the printhead passes the same area increases to obtain an image almost free from a stripe or unevenness though the throughput decreases.

Embodiments of concrete features of the present invention for completing an image by multipass bidirectional printing used in the above-described printing system will be explained.

### First Embodiment

In the first embodiment, printing is done using a combination of masks prepared in a memory in accordance with the position where an image is printed. In the first embodiment, 4-pass printing is executed to complete an image by four scanning operations with cyan (C), magenta (M), yellow (Y), and black (K) inks.

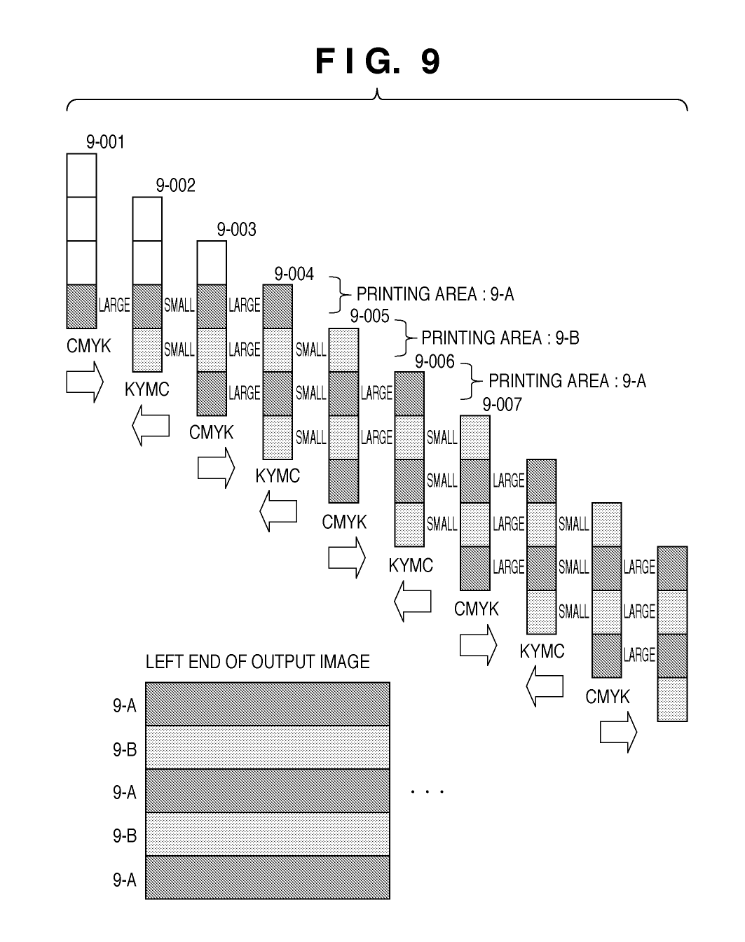

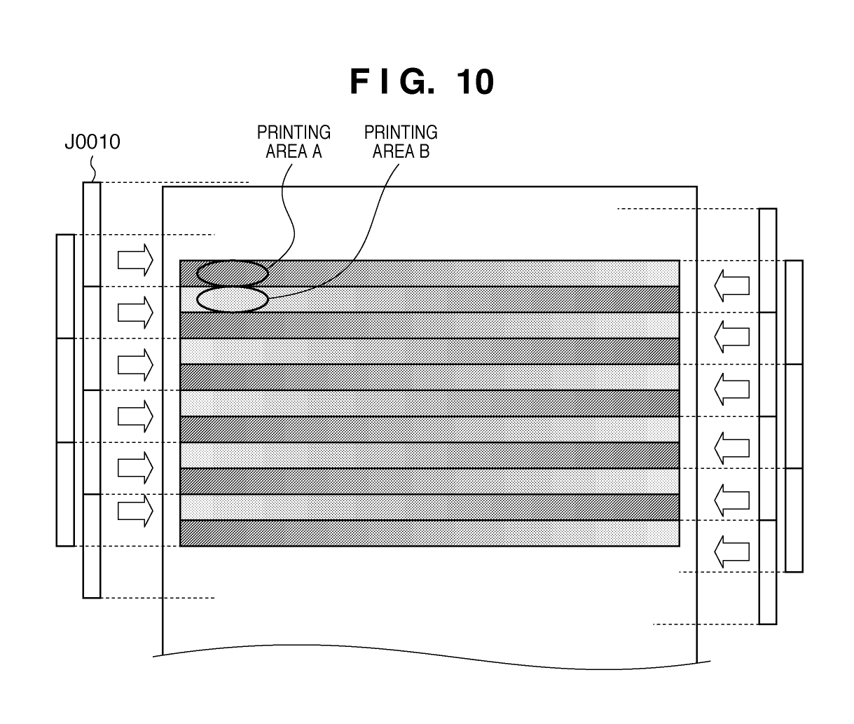

Each process of 4-pass printing will be described first with reference to FIG. 9. The printhead has a nozzle array (printing element array) of 1,280 nozzles for each color, and the nozzle arrays of the respective colors are juxtaposed.

In first print scanning 9-001, printing is done as reverse printing by discharging C, M, Y, and K inks in the order named from ¼ nozzles (320 nozzles) at the leading end of the nozzle array. After an image is printed to the right end in FIG. 9, the printhead scanning direction is reversed, and paper is fed by an amount corresponding to a ¼ width (320 pixels) of the nozzle array.

In second print scanning 9-002, printing is done as forward printing by discharging K, Y, M, and C inks in the order named from 2/4 nozzles at the leading end of the nozzle array while the printhead returns to the left end of a print image in FIG. 9. Then, the printhead scanning direction is reversed, and paper is fed by an amount corresponding to the ¼ width of the nozzle array. In the second print scanning, ¼ nozzles at the leading end of the nozzle array print based on divided print data for the first pass in an area where printing is done for the first time by the second print scanning. Further, ¼ nozzles near the center of the nozzle array print based on divided print data for the second pass in an area where printing has been done by the first print scanning.

In third print scanning 9-003, printing is done as reverse printing by discharging C, M, Y, and K inks in the order named from ¾ nozzles at the leading end of the nozzle array, and paper is fed by an amount corresponding to the ¼ width of the nozzle array. Also in the fourth and subsequent print scanning operations, these operations are repeated to complete printing of an image.

In an area (also called a printing band) printed by the first print scanning, ink droplets land in the order of C, M, Y, and K by the first pass, K, Y, M, and C by the second pass, C, M, Y, and K by the third pass, and K, Y, M, and C by the fourth pass.

In an area printed for the first time by the second print scanning, ink droplets land in the order of K, Y, M, and C by the first pass, C, M, Y, and K by the second pass, K, Y, M, and C by the third pass, and C, M, Y, and K by the fourth pass.

In the first embodiment, an A0-size image is printed as an image of a large format (A4 size or more). Thus, the width of a print image in the printhead scanning direction (main scanning direction) is large, and the inter-pass time difference described as a conventional problem changes in printing at the end of a print image in the main scanning direction. Large and small inter-pass time differences are combined for each band. The time interval between print scanning operations at a portion where the inter-pass time difference is small at the end of a print image is about 0.2 sec because the printhead moves by an idle feed distance of about several centimeters for acceleration/deceleration after preceding print scanning, then reverses, and prints. To the contrary, when the carriage speed in printing is 25 inches/sec, the time interval between print scanning operations at a portion where the inter-pass time difference is large at the end of a print image is about 2.2 sec which is the sum of the time taken for forward printing, the time taken to reverse the carriage, and the time taken for reverse printing.

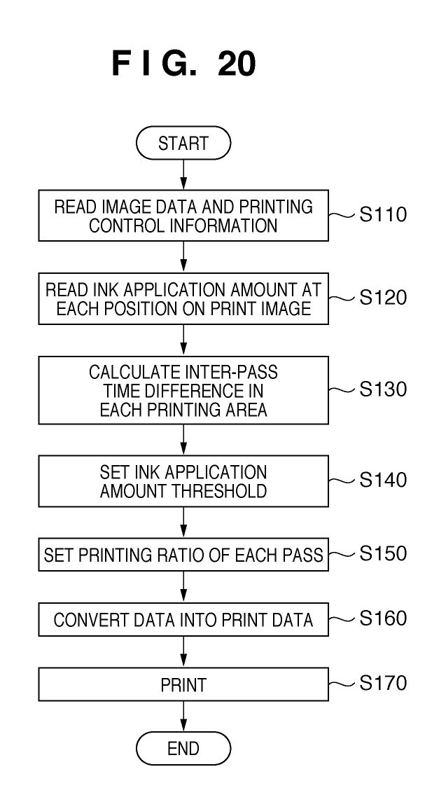

A printing method according to the present invention will be described with reference to the flowchart of FIG. 20.

In step S110, image data and printing control information are read. The printing apparatus reads multilevel image data of an image to be printed from a PC, and in the first embodiment, binarizes it by error diffusion. At the same time, the printing apparatus reads control information necessary for printing as a printing control instruction including the number of passes and the width of a print image.

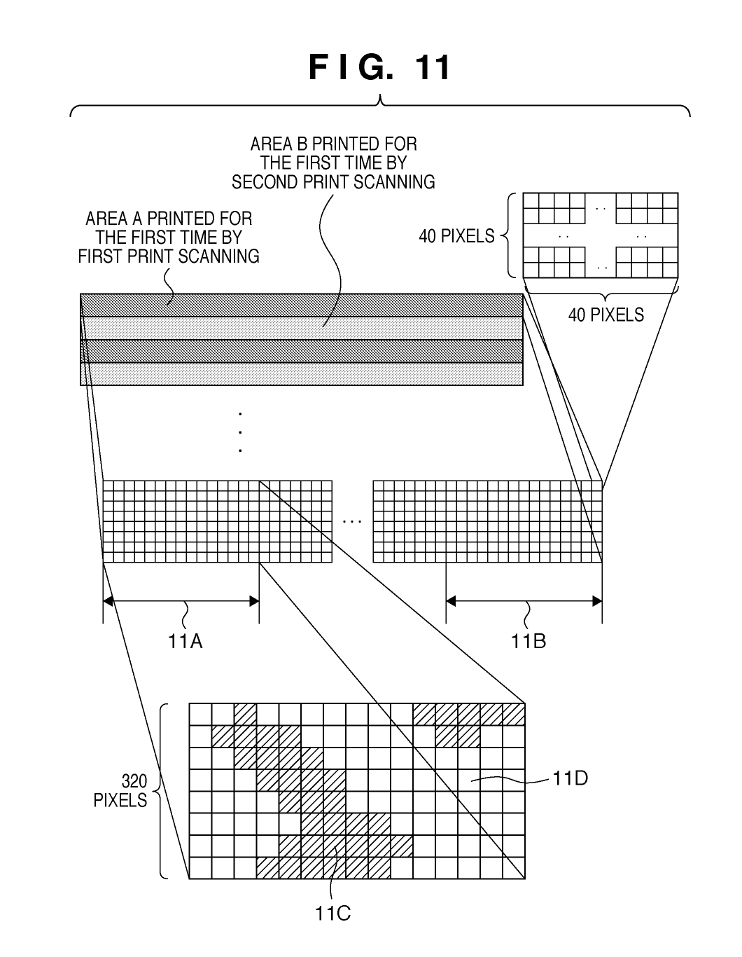

In step S120, the ink discharge amount (ink application amount) at each position on a print image is read. The application amount of each ink is read for each image area of 40 pixels×40 pixels as shown in FIG. 11 on the basis of the image data read in step S110 and a lookup table (LUT) representing the relationship between the image density and the ink application amount. That is, the total ink application amount (total ink discharge amount) is acquired in the image area at each position on a print image. The size of the image area may also be larger or smaller than the above-described one, and the image area may also have a shape other than the square and rectangle.

In step S130, the inter-pass time difference in each printing area is calculated. As described above, the time interval between print scanning operations at a portion where the inter-pass time difference is small at the end of a print image is about 0.2 sec, and the time interval between print scanning operations at a portion where the inter-pass time difference is large is about 2.2 sec. In an area where the time interval between the first and second passes is 2.2 sec, the time interval between the second and third passes is 0.2 sec, and that between the third and fourth passes is 2.2 sec. In an area adjacent to this area in a band adjacent to the band of this area, the time interval between the first and second passes is 0.2 sec, that between the second and third passes is 2.2 sec, and that between the third and fourth passes is 0.2 sec.

In step S140, the ink application amount threshold is set as the first threshold in order to specify the position of an image area where the printing ratio of each pass is to be changed. In the first embodiment, the threshold is set for a position where the inter-pass time difference exceeds 1.2 sec. The inter-pass time difference serving as a reference can be changed in accordance with the printhead scanning speed, the time taken to kick back the printhead, the ink type and print medium type used for printing, and the like. As the position where the inter-pass time difference exceeds 1.2 sec, a left end image area 11A and right end image area 11B (20-cm wide areas at the two ends of the image) in FIG. 11 are set. In the first embodiment, the time taken to kick back the printhead is different between the left end image area 11A and the right end image area 11B, so the ink application amount for changing the allocation of the printing ratio depending on band unevenness is different. In the first embodiment, therefore, the ink application amount threshold is set to 12 ml/m² for the left end image area 11A and 18 ml/m² for the right end image area 11B.

In step S150, the printing ratio of each pass is set for an image area at a position where the ink application amount exceeds the threshold as a result of a comparison with the threshold set in step S140. The area of an image where the total ink application amount at each position of the image area exceeds an ink application amount serving as an arbitrary threshold set as a parameter for each ink and print medium is extracted. In the first embodiment, an area of 40×40 pixels is defined as a unit area, and the area where the ink application amount exceeds the threshold is extracted for each unit area. Of an area 11C where the ink application amount exceeds the threshold and an area 11D where the ink application amount is equal to or smaller than the threshold in FIG. 11, the area 11C is an extracted image area, and an area where band unevenness readily occurs is selected based on the ink application amount and the position in the image. The selected area is defined as a position to which a mask is applied to allocate a printing ratio separately designed to prevent band unevenness.

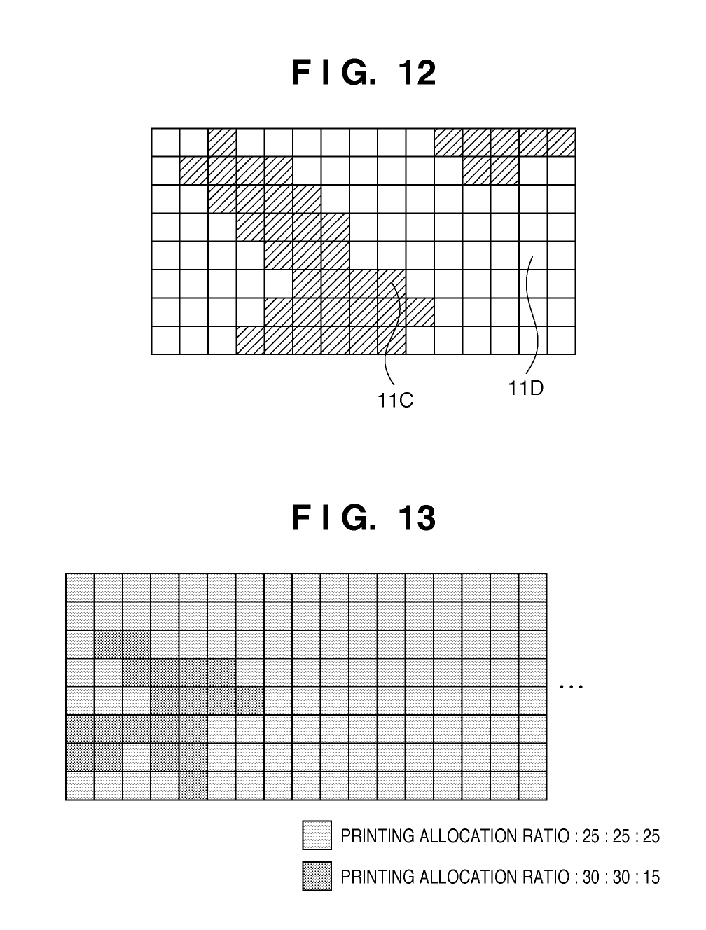

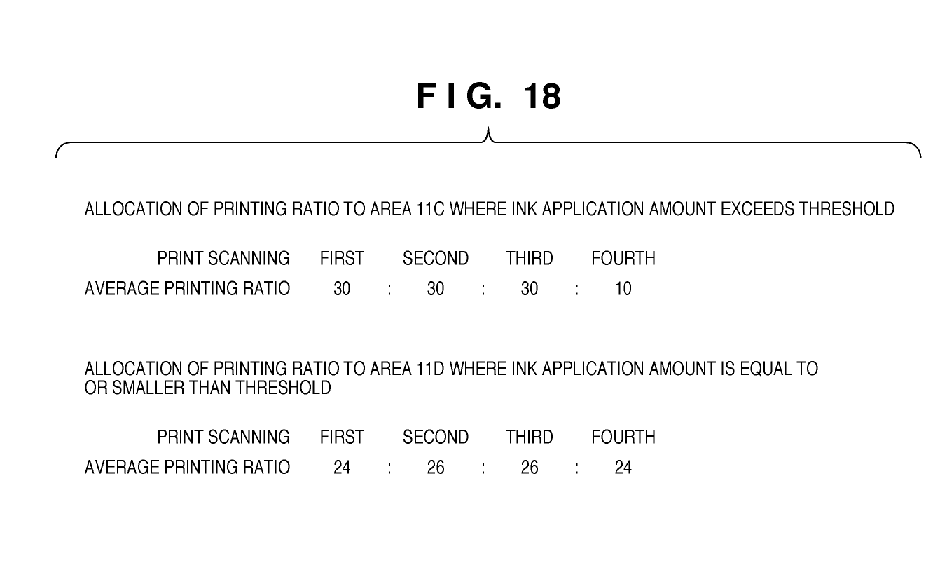

FIG. 12 is an enlarged view of part of FIG. 11. A blank area in FIG. 12 is an area printed by normal 4-pass printing at a printing ratio of 24%, 26%, 26%, and 24%. A hatched area where the ink application amount exceeds the threshold is an area printed at a printing ratio of 30% by the first pass, 30% by the second pass, 30% by the third pass, and 10% by the fourth pass. FIG. 18 shows the set values of printing ratios allocated to the area 11C where the ink application amount exceeds the threshold (area where the ink application amount exceeds the first threshold), and the set values of printing ratios allocated to the area 11D where the ink application amount is equal to or smaller than the threshold (area where the ink application amount is equal to or smaller than the first threshold).

As described above, in this example, the printing ratio allocation of 30:30:30:10 is set for only an area where the ink application amount is large and the influence of time difference unevenness is especially serious. The influence of time difference unevenness is serious in the area where the ink application amount is large because previously applied ink hardly dries, the print medium is wet, and thus the penetration of ink applied later is promoted to decrease the density.

In step S160, the data binarized in step S110 is converted into print data which redefines discharge/non-discharge from each nozzle of the printhead by each pass on the basis of the printing ratio of each pass set in step S150. In this case, the binary data is converted into print data which redefines again discharge/non-discharge by combining a mask for masking the entire area shown in FIG. 12, and a mask having a size of 40 pixels×40 pixels serving as a unit area. It is not preferable that masked pixels are intentionally successive among pixels at the boundary between the two masks.

In step S170, printing is executed by four passes on the basis of the print data generated in step S160.

A material printed by these procedures is almost free from a boundary stripe. Further, the nozzle use frequency is leveled, and band unevenness is reduced even in an image area where the ink application amount is large.

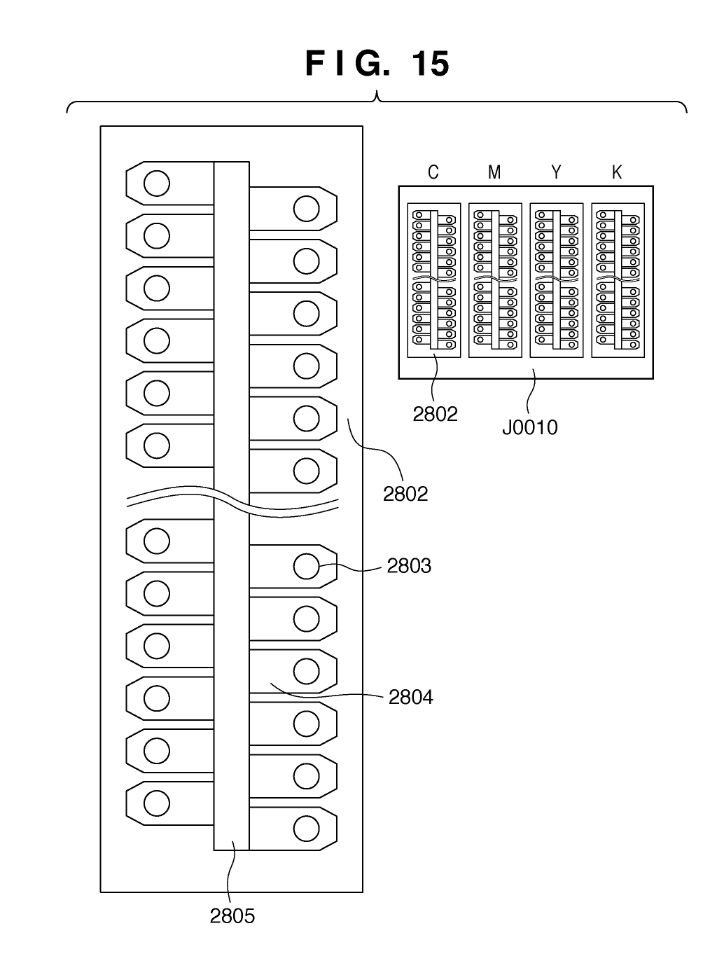

As an experimental condition in the first embodiment, the print medium was “thick coated paper LFM-CPA00S of A0 size available from CANON”. Inks were those stored in ink tanks “PFI-102 C, M, Y, and K available from CANON” for imagePROGRAPH iPF700. Printing was performed using the printhead shown in FIG. 15 at a printing frequency of 15 kHz and a printhead scanning speed of 25 inches/sec. The printhead was one in which 1,280 nozzles for discharging an ink droplet of about 4.5 pl were arrayed at a resolution of 1,200 dpi in correspondence with each ink. The printed image was an image of 36 inches wide as a large format size.

### Second Embodiment

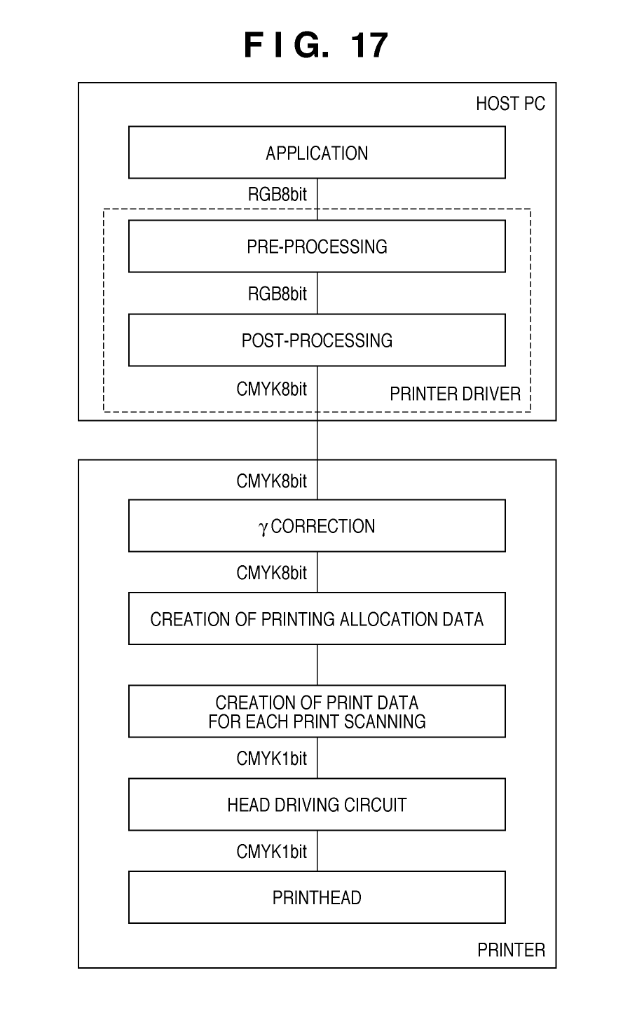

In the second embodiment, the same apparatus as that in the first embodiment is used to receive multilevel image data from a PC, divide it without converting it, and binarize the divided multilevel data when converting it into print data used for printing by each pass. FIG. 17 is a block diagram showing main data processes till printing in the second embodiment.

A printing method according to the second embodiment will be described with reference to the flowchart of FIG. 20.

Similar to the first embodiment, image data and printing control information are read in step S110. In the second embodiment, however, the image data is not binarized in this step. Steps S120 to S150 are the same as those in the first embodiment.

In step S160, the multilevel image data read in step S110 is divided into multilevel data for printing by respective passes on the basis of the printing ratios of these passes set in step S150. The divided multilevel image data is converted into binary print data which is used for printing and defines discharge/non-discharge. Images areas are smoothly concatenated at their boundary by error diffusion-based binarization, preventing generation of a texture at an area size pitch. Processing in step S170 is the same as that in the first embodiment.

A material printed by these procedures is almost free from band unevenness or a boundary stripe. In addition, the nozzle use frequency is leveled, and band unevenness is reduced even in an image area where the ink application amount is large.

### Third Embodiment

The third embodiment will describe a case where input of image data from a PC delays or a case where an inter-pass time difference larger than one in normal printing is generated owing to the maintenance of the printhead. For example, after printing starts at equal printing ratios in all print scanning operations on the basis of image data for which no printing ratio allocation need be changed, the printhead retracts to a predetermined position during printing owing to the above-mentioned reason. The present invention is applicable to even this case. The third embodiment will exemplify a case where data transfer from a PC delays because of any reason and a 5-sec standby time is generated after the end of the first print scanning during printing.

In this case, printing has ended by 25% by the first print scanning. At this time, the remaining 75% of printing is executed by three remaining print scanning operations. The printhead stands still at the right end of the image during the standby time, so the standby time till the next print scanning becomes the sum of 2.2 sec+5 sec=7.2 sec at the left end of the image. Since the inter-pass time difference becomes larger, the allocation of the printing ratio needs to be changed to print in an image area where it is determined at first from the total ink application amount calculated from image data that there is no need to change the allocation of the printing ratio to print. This image area is an area where the ink application amount exceeds 12 ml/m². Thus, the ink application amount threshold is decreased from 12 ml/m² to 8 ml/m², and the printing ratio of the remaining three print scanning operations is changed to 4:4:2. As shown in FIG. 13, an image area where the ink application amount exceeds the second threshold serving as a new ink application amount is designated, and the designated image area is printed at a printing ratio of 30:30:15.

The third embodiment is generalized as follows. When the printing apparatus suspends printing while printing by scanning the same area of a print medium n times, the total ink application amount is compared with a newly defined second threshold in the end area of an image area where the m-th printing (m<n) has been executed upon suspension. In the end area where the total ink application amount exceeds the second threshold, ink application amounts are reallocated to the (m+1)th and subsequent scanning operations, and then printing is executed.

The third embodiment can also reduce band unevenness caused by generation of the standby time, and prevent disturbance of a stripe considered to be caused by disturbance of an air flow. Further, the third embodiment can prevent excessive localization of the nozzle use frequency.

### Fourth Embodiment

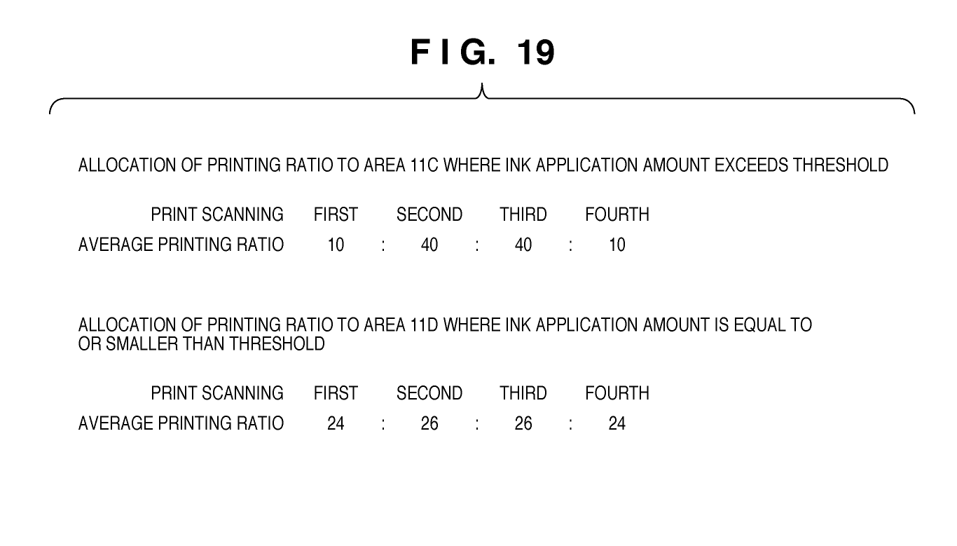

In the fourth embodiment, printing is done under the same conditions as those in the first embodiment except that the allocation of the printing ratio is set to 10:40:40:10 in an image area where the ink application amount exceeds the threshold, as shown in FIG. 19. That is, an extracted image area is printed at a lower printing ratio by the first and final passes than in the remaining area.

The fourth embodiment can also reduce both a boundary stripe and band unevenness, and also reduce localization of the nozzle use frequency.

### Fifth Embodiment

If the standby time is generated, as described above, band unevenness sometimes becomes conspicuous. For example, when a large-format printer prints a relatively small image of A3 size or less, the printhead may not reverse quickly in the first print scanning after the end of printing an image by this print scanning. In some cases, the printhead moves to an end opposite to the printing start end, performs preliminary discharge or the like, and then reverses to perform print scanning in the opposite direction. At this time, band unevenness appears at the left end of the image serving as the printing start end. The present invention is applicable to even this case.

The allocation of the printing ratio is set to 30:30:30:10 at the left end of an image serving as the image printing start end in the main scanning direction, and 24:26:26:24 at the right end of the image. This means that an image at the left end is complete at different printing ratios from those in the remaining area so as to decrease the printing ratio of the final pass. The left and right ends of an image are determined from the idle feed distance serving as a distance by which the printhead moves without printing. In the fifth embodiment, when the idle feed distance coincides with a print medium scanning distance A0, 20-cm wide areas from the two ends of an image are defined as the left and right ends of the image, similar to the first embodiment. Printing is done by changing the allocation of the printing ratio in an area where the ink application amount exceeds the threshold in each 20-cm wide area, obtaining a good printing result.

In the above-described embodiments, the printing ratio of each ink in printing by the final scanning is set smaller than the average one in printing by the remaining scanning operations in an end area where the ink discharge amount exceeds a predetermined threshold.

The effect of the above-described printing ratio allocation to the respective passes of multipass printing on reducing band unevenness will be described.

A print medium to be printed has various pores of different sizes. For example, if ink receptive layer as like silica is coated on a base paper as like a mat coated paper, it is assumed that pore with a several μm order and pore with an order less than or equal to an inner of a silica particle body.

When ink discharged from the printhead lands on the surface of a print medium, ink (color material) penetrates into a pore of a relatively large size, and then moves to a pore of a relatively small size and is fixed there.

When there is a sufficient time difference between previously discharged ink and subsequently discharged ink, the previous ink penetrated into a pore of a relatively large size and has already moved to a pore of a relatively small size, and the subsequent ink can penetrate into a pore of a relatively large size in the print medium. If the time difference between previous ink and subsequent ink is not sufficient, since the previous ink still remains in a pore of a relatively large size, it is assumed that the subsequent ink cannot penetrate into the print medium. Further, it is also assumed that the subsequent ink penetrated more deeply and fixed there via the pore of the large size where the previous ink which has already moved to the pore of the small size. Depending on the time difference between previous ink and subsequent ink, the subsequent ink penetrates into at a shallow position of the print medium to increase the density, or penetrates into at a depth position of the print medium to increase the density. Thus, from a point of view of density change of printing image, when a plurality of inks are discharged, it is concluded that influence of the finally discharged ink is important.

In multipass printing, therefore, ink discharged by the final pass greatly influences the density of each band. However, if the printing ratio of the final pass is low, the ink amount which influences the density is small, reducing the density difference between an area where printing is done by the final pass with a large time difference and an area where printing is done by the final pass with a small time difference.

From this, in multipass printing, the printing ratio of the final pass is decreased to set the printing ratio of the final scanning lower than the average printing ratio of the remaining scanning operations. Density variations between areas depending on the time difference can be reduced to suppress the influence of time difference unevenness.

As for application order unevenness, the printing order of finally discharged ink most influences the color tint of each band. Similarly, the printing ratio of the final scanning is set lower than the average printing ratio of the remaining scanning operations, reducing the influence of application order unevenness.

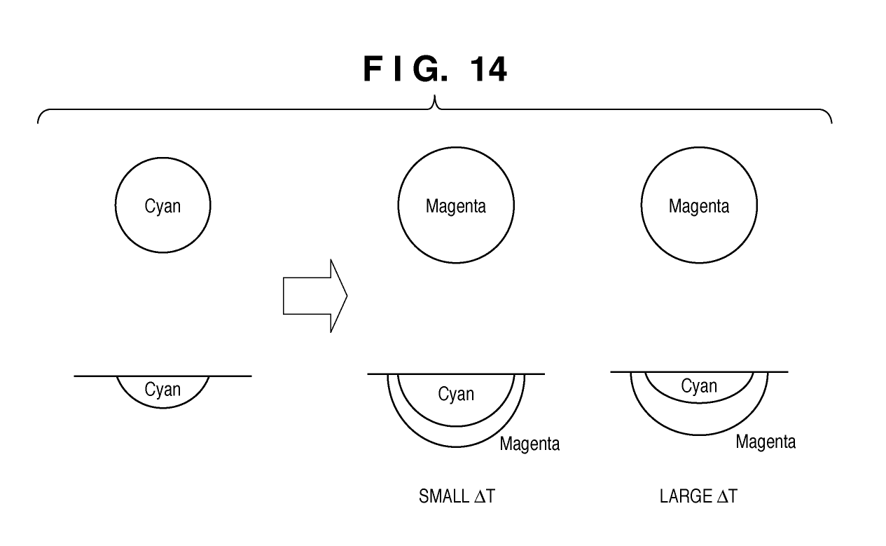

Further, as for application order unevenness, on the basis of penetration phenomenon in FIG. 14, since there is difference about penetration depth of ink between previously discharged ink and subsequently discharged ink, it is concluded that what color is previously discharged at a pass in an early phase decides color of ink fixed on a surface. Therefore, by decreasing the printing ratio at a pass in an early phase, it is assumed that influence to the application order unevenness can be decreased, and ink application amount as shown in FIG. 19 can be reduced.

In the above-described embodiments, the printing ratios in an end area where the ink application amount is equal to or smaller than the threshold are substantially uniformly allocated to 24:26:26:24 in consideration of the discharge disturbance and the like at the end of the nozzle array owing to an air flow. However, the printing ratios may also be completely uniformly allocated to 25:25:25:25. In this case, the nozzle use frequency can be further leveled.

Even in an end area where the ink discharge amount is equal to or smaller than the threshold, the printing ratio of the final scanning may also be set lower than the average one of the remaining scanning operations, such as 26:26:26:22. However, the end area where the ink discharge amount is equal to or smaller than the threshold is an area where the influence of band unevenness is not serious. It is, therefore, desirable to consider the localization of used nozzles and the adverse effect of a change of an air flow when the printing ratio of the final scanning is set much lower than the average one of the remaining scanning operations. The difference between the printing ratio of the final scanning and the average one of the remaining scanning operations in an end area where the ink discharge amount is equal to or smaller than the threshold is preferably smaller than the difference between the printing ratio of the final scanning and the average one of the remaining scanning operations in an end area where the ink discharge amount exceeds the threshold.

In the above-described embodiments, dye ink and mat thick coated paper are used, but pigment ink and paper such as inkjet glossy paper or wood-free paper other than coated paper are also available. Low-density, light-color ink (light cyan ink or light magenta ink), and ink of a spot color such as red, blue, or green are also available.

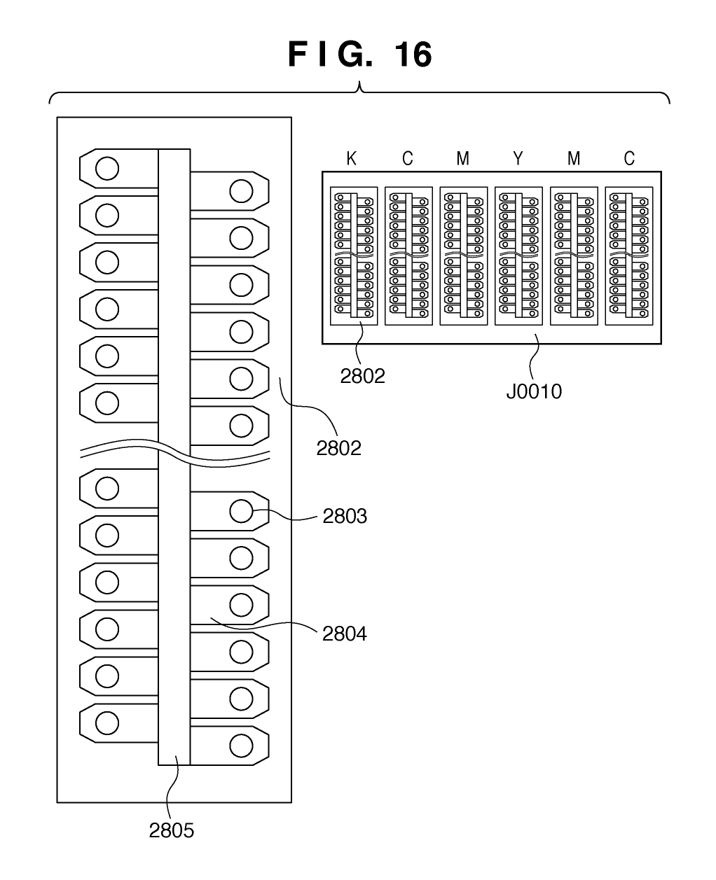

A printhead configured by symmetrically arranging color ink nozzle arrays as shown in FIG. 16 is also available. A printhead configured to discharge ink of the same color at different discharge volumes is also available.

As described above, the present invention can adopt a liquid other than color material-containing ink. An example of this liquid is a reaction solution which coagulates or insolubilizes the color material in ink. The reaction solution can prevent generation of unevenness caused by the time difference when applying at least one type of ink and the reaction solution.

The above-described embodiments have exemplified 4-pass printing achieved by four scanning operations, but the present invention is also applicable to 5- or 6-pass printing.

The printhead for a plurality of colors is uniformly masked in the above-described embodiments, but only some colors may also be masked. For example, it is known that an ink whose color material tends to coagulate, like some cyan inks, tends to suffer from application order unevenness and time difference unevenness. The present invention may also be applied to only such cyan ink.

The above-described embodiments can achieve high-density, high-resolution printing by a method of changing the ink state by heat energy using a means for generating heat energy to discharge ink, especially among inkjet printing methods. However, the present invention may also adopt a piezoelectric method or the like other than the method of changing the ink state by heat energy.

The present invention can also use a full line type printhead having a length corresponding to the width of a maximum print medium printable by the printing apparatus. The printhead may take a structure which satisfies this length by combining a plurality of printheads, or the structure of one integrally formed printhead.

In addition, the present invention may also employ a cartridge type printhead configured by integrating an ink tank with the printhead, or an exchangeable chip type printhead which can be electrically connected to the apparatus main body and receive ink from it when mounted on it.

A recovery means for the printhead, preliminary means, and the like can be preferably added to the above-described arrangement of the printing apparatus to further stabilize the printing operation. These means include, for the printing head, a capping means, cleaning means, pressurization or suction means, and preliminary heating means using an electrothermal transducer, another heating element, or a combination of them. It is also effective for stable printing to prepare a preliminary discharge mode in which ink is discharged independently of printing.

The embodiments of the present invention have described ink as a liquid, but the present invention is also applicable to an ink which is solid at room temperature or less and softens or liquefies at room temperature.

The printing apparatus according to the present invention may also take the form of an image output terminal integrated with or separately arranged for an information processing device such as a computer, the form of a copying machine combined with a reader and the like, or the form of a facsimile apparatus having transmission and reception functions.

The present invention reduces band unevenness such as application order color unevenness or time difference unevenness by changing the allocation of printing ratios to respective passes by only a necessary amount in an image area where the ink application amount is especially large. Since the allocation of the printing ratio is not changed in an image area where change of the allocation is unnecessary, change of color by disturbance of an air flow upon changing the printing ratio distribution of the nozzle array of the printhead can be suppressed.

Further, the present invention can reduce localization of the printing element use frequency, uniform changes of printing elements over time, and as a result, prolong the service life of the printhead.

The present invention can reduce band unevenness even in a multipass printing mode in which the number of passes is small, and level the nozzle use frequency. At the same time, a high-quality printed material can be obtained quickly without generating any boundary stripe.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-171224 filed on Jun. 28, 2007, which is hereby incorporated by reference herein in its entirety.

What is claimed is:

1. An inkjet printing apparatus which prints using a printhead for discharging ink by a plurality of scanning operations of the printhead including forward scanning and reverse scanning in a single area of a print medium, the apparatus comprising:
acquisition means for acquiring an ink discharge amount for each unit area obtained by dividing an end area of the single area in a scanning direction;
comparison means for comparing the ink discharge amount of each unit area acquired by said acquisition means with a predetermined threshold; and
control means for controlling printing ratios of the plurality of scanning operations to set a printing ratio of a final scanning operation lower than an average printing ratio of remaining scanning operations in a unit area where the ink discharge amount is larger than the predetermined threshold.

2. The apparatus according to claim 1, wherein said control means controls to make printing ratios of the plurality of scanning operations equal to each other in a unit area where the ink discharge amount is not larger than the predetermined threshold.

3. The apparatus according to claim 1, wherein
said control means controls to set the printing ratio of the final scanning operation lower than the average printing ratio of the remaining scanning operations in a unit area where the ink discharge amount is not larger than the predetermined threshold, and
said control means controls to set a difference between the printing ratio of the final scanning operation and the average printing ratio of the remaining scanning operations in the unit area where the ink discharge amount is not larger than the predetermined threshold smaller than a difference between the printing ratio of the final scanning operation and the average printing ratio of the remaining scanning operations in the unit area where the ink discharge amount is larger than the predetermined threshold.

4. The apparatus according to claim 1, wherein the predetermined threshold is different between the end area on one end in the scanning direction and the end area on the other end.

5. The apparatus according to claim 1, wherein when printing stops,
said acquisition means acquires an ink discharge amount till the stop for each unit area,
said comparison means compares the ink discharge amount till the stop acquired by said acquisition means for each unit area with a second threshold smaller than the predetermined threshold, and
said control means controls the printing ratios of the plurality of scanning operations to set the printing ratio of the final scanning operation lower than the average printing ratio of the remaining scanning operations after the stop in a unit area where the ink discharge amount till the stop is larger than the second threshold.

6. An inkjet printing method of printing using a printhead for discharging ink by a plurality of scanning operations of the printhead including forward scanning and reverse scanning in a single area of a print medium, the method comprising:
an acquisition step of acquiring an ink discharge amount for each unit area obtained by dividing an end area of the single area in a scanning direction; and
a comparison step of comparing the ink discharge amount of each unit area acquired in the acquisition step with a predetermined threshold,
wherein printing ratios of the plurality of scanning operations are controlled to set a printing ratio of a final scanning operation lower than an average printing ratio of remaining scanning operations in a unit area where the ink discharge amount is larger than the predetermined threshold.
